(19) United States
(12) Patent Application Publication
(10) Pub. No.: US 2009/0030656 A1
(43) Pub. Date: Jan. 29, 2009

(54) METHOD AND SYSTEM FOR COMPENSATING FOR MISALIGNMENT OF A TARGET PIECE OF MATERIAL TO WHICH A DESIGN IS TO BE APPLIED

(76) Inventors: Michael Ray Doe, II, Thornton, CO (US); Donald Richard Grayson, Parker, CO (US); Robert Bruce Ton, Arvada, CO (US); Jeffrey Thomas Block, Westminster, CO (US); Scott David Stengel, Golden, CO (US)

Correspondence Address: COOLEY GODWARD KRONISH LLP;ATTN: Patent Group, Suite 1100, 777 - 6th Street, NW, WASHINGTON, DC, 20001, US

(21) Appl. No.: 11/782,600

(22) Filed: Jul. 24, 2007

(51) Int. Cl. G06F 17/50

(52) U.S. Cl. 703/1

(57) ABSTRACT

A method and system for compensating for misalignment of a piece of target material to which a design is to be applied is described. One embodiment receives first and second sets of coordinates corresponding to the location, respectively, of first and second reference points on the target piece of material; modifies, based on the received first and second sets of coordinates, design data that specifies a predetermined position and orientation of the design on the target piece of material with respect to the first and second reference points to produce modified design data, the modified design data compensating for at least one of translational and rotational misalignment of the target piece of material with respect to a design-application mechanism; and applies the design to the target piece of material in accordance with the modified design data.

### FIELD OF THE INVENTION

The present invention relates generally to methods and apparatuses for applying a design to a target piece of material. More specifically, but not by way of limitation, the present invention relates to computerized methods and systems for compensating for misalignment of the target piece of material in a design-application apparatus.

### BACKGROUND OF THE INVENTION

In applying a design to a target piece of material such as a piece of fabric, a garment, or a portion of a garment, proper positioning and alignment of the target piece of material relative to the stitching or printing apparatus is important. Otherwise, the design might end up on the wrong part of the target piece of material, might be tilted at the wrong angle, or both.

A typical embroidery machine will serve to illustrate this problem. Typical embroidery machines include a sewing head, an X-Y assembly, and a hook and bobbin assembly. The sewing head is commonly a multi-needle head, containing several needles which are used to stitch different thread colors. The sewing head is commonly located on a carriage at the front of the embroidery machine and is movable on the carriage to locate a first needle in a stitching position above the hook and bobbin assembly to stitch a first thread color into the garment. When a second thread color needs to be stitched into the garment, the sewing head is moved on the carriage to locate a second needle in a stitching position above the hook and bobbin assembly to stitch the second thread color into the garment.

When performing stitching operations, the embroidery machine, as is common and well known in the industry, moves the needle containing an upper thread through the garment. There is typically a needle plate located beneath the garment which the needle projects through when it has moved through the garment. Beneath the needle plate is the hook and bobbin assembly. The hook rotates around a lower thread which is fed from the bobbin. The hook rotates to catch the upper thread, and carries the upper thread around the lower thread as the hook rotates. When the hook nears the completion of its revolution, the needle is pulling back through the needle plate and garment, and the upper thread disengages from the hook. When the needle pulls the rest of the way through the garment, the upper thread is pulled around the lower thread and becomes taught, thus securing, or locking, the stitch. The X-Y assembly then moves the garment to an appropriate position for the next stitch, and the process is repeated.

The X-Y assembly is secured to the embroidery machine and is adapted to be connected to a hoop which contains a garment to be stitched. The X-Y assembly contains an X and a Y positioning mechanism which moves the hoop in both the X and Y directions with respect to the embroidery machine. When stitching a pattern, the X-Y assembly moves the hoop in a preset pattern with respect to the stitching needle, and a pattern in thus stitched into the garment.

Difficulties arise if the garment is placed into the hoop at a different position and/or alignment than expected. In such a case, the pattern will be stitched into the garment incorrectly. The likelihood of misalignment is significant because the garment is typically placed into the hoop manually by a human operator. The conventional solution is for the operator to adjust the garment to correct the misalignment, but this takes extra time and is still not sufficiently accurate in some cases.

Similar misalignment problems can arise with apparatuses that print designs onto fabric such as a screen printing apparatus or a garment printer. The latter is a device that prints designs onto fabric in much the same way that a document printer prints onto paper.

It is thus apparent that there is a need in the art for an improved method and system for compensating for misalignment of a target piece of material to which a design is to be applied.

### SUMMARY OF THE INVENTION

Illustrative embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents, and alternative constructions that fall within the spirit and scope of the invention as expressed in the claims.

The present invention can provide a method and system for compensating for misalignment of a target piece of material to which a design is to be applied. One illustrative embodiment is a method for applying a design to a target piece of material, comprising receiving a first set of coordinates corresponding to a location of a first reference point on the target piece of material; receiving a second set of coordinates corresponding to a location of a second reference point on the target piece of material; modifying, based on the received first and second sets of coordinates, design data that specifies a predetermined position and orientation of the design on the target piece of material with respect to the first and second reference points to produce modified design data, the modified design data compensating for at least one of translational and rotational misalignment of the target piece of material with respect to a design-application mechanism; and applying the design to the target piece of material in accordance with the modified design data.

This and other embodiments are described in greater detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings, wherein:

FIG. 1 is a functional block diagram of a system for applying a design to a target piece of material in accordance with an illustrative embodiment of the invention;

FIG. 2 is a functional block diagram of a design-application apparatus in accordance with another illustrative embodiment of the invention;

FIG. 3A is an illustration of a target piece of material that has been placed in a hoop and on which reference points have been defined in accordance with an illustrative embodiment of the invention;

FIG. 3B is an illustration showing a situation in which a target piece of material has been misaligned with respect to a design-application mechanism in accordance with an illustrative embodiment of the invention;

FIG. 3C is an illustration showing reference points that are defined in terms of a feature of the target piece of material other than added visible marks in accordance with an illustrative embodiment of the invention; and

FIG. 4 is a flowchart of a method for applying a design to a target piece of material in accordance with an illustrative embodiment of the invention.

### DETAILED DESCRIPTION

Rather than physically repositioning a target piece of material to correct misalignment, a better solution is to measure the actual position and alignment of the target piece of material in the design-application apparatus and to adjust the placement of the design using computerized methods. In this way, the design itself is automatically translated and/or rotated to compensate for the misalignment. Optionally, the design can also be scaled in size to fit within a predetermined area of the target piece of material such as a patch or pocket.

Herein, “target piece of material” refers to any piece of material to which a design can be applied, such as, without limitation, a piece of fabric, a piece of leather or imitation leather, a garment, or a portion of a garment. “Design” is used broadly herein to refer to any text and/or graphics applied to a target piece of material. A “design-application apparatus” refers to an apparatus that is capable of applying a design to a target piece of material. Examples include, without limitation, embroidery machines, other types stitching or sewing machines, screen-printing apparatuses, and garment printers.

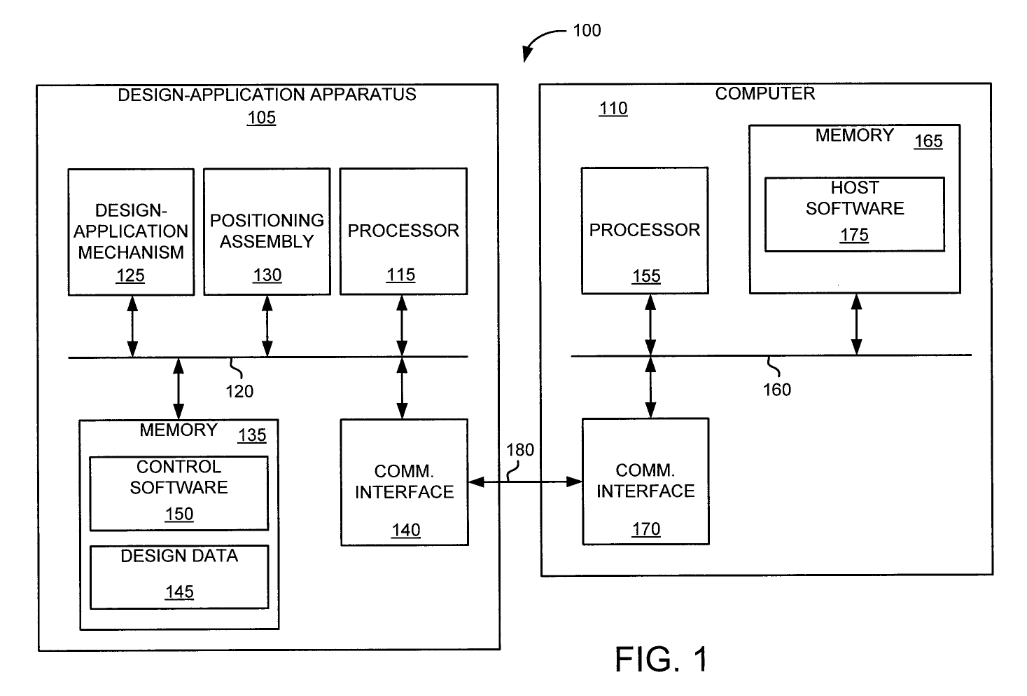

Referring now to the drawings, where like or similar elements are designated with identical reference numerals throughout the several views, and referring in particular to FIG. 1, it is a functional block diagram of a system 100 for applying a design to a target piece of material in accordance with an illustrative embodiment of the invention. System 100 includes design-application apparatus 105 and computer 110, which are connected by communication link 180. Communication link 180 may be, for example, an Ethernet connection or any other suitable communication link, whether hardwired or wireless. In some embodiments, multiple design-application apparatuses 105 are networked to one or more computers 110. In some embodiments, computer 110 acts as a server and design-application apparatus 105 acts as a client in a client-server model.

Design-application apparatus 105 includes a processor 115 that communicates over data bus 120 with design-application mechanism 125, positioning assembly 130, memory 135, and communication interface 140.

Design-application mechanism 125 is the portion of design-application apparatus 105 that physically applies a design to a target piece of material. For example, in an embroidery machine, design-application mechanism 125 includes a sewing head, an X-Y assembly, and a hook and bobbin assembly (not shown in FIG. 1). The particular nature of design-application mechanism 125 differs depending on what technology is used to apply the design to the target piece of material.

Positioning assembly 130 aids an operator in determining exactly where a needle or other design-application instrument will contact the target piece of material. Examples include, without limitation, optical positioning assemblies and mechanical positioning assemblies. An optical positioning assembly includes a laser or other light source that shines a dot of light (an optical positioning marker) onto the target piece of material to indicate where the needle or other design-application instrument will contact the target piece of material. This is similar to the alignment technique used in some commercially available miter saws. An optical positioning assembly for use in an embroidery machine is described in further detail in commonly assigned U.S. Pat. No. 6,732,668, “Light Indicating in Computerized Stitching,” which is incorporated herein by reference.

In a different embodiment, positioning assembly 130 is mechanical rather than optical. One example of a mechanical positioning assembly is a plumb bob that hangs down to indicate a reference position. Other types of mechanical positioning techniques are well known to those skilled in the applicable art.

Memory 135 includes design data 145 and control software 150. Depending on the particular embodiment, memory 135 may include, for example, random-access memory (RAM), read-only memory (ROM), flash memory, magnetic disk storage, optical storage, other types of memory, or a combination thereof.

Design data 145 includes information that specifies a particular design. That is, design data 145 provides design-application apparatus 105 with the spatial information it needs to apply a particular design to the target piece of material. Design data 145 is derived in advance from an image (graphical) file of the design and is stored in a design repository (not shown in FIG. 1). In one embodiment, the design repository resides on computer 110, and an operator, via a suitable user interface on either design-application apparatus 105 or computer 110, selects a particular design to apply to the target piece of material, the design data corresponding to which is downloaded to memory 135 of design-application apparatus 105.

Control software 150 is executed by processor 115 to control the operation of design-application mechanism 125 in applying to the target piece of material the design specified by design data 145. As explained below, in some cases design data 145 is modified based on measurements to correct for misalignment of the target piece of material with respect to the design-application mechanism 125. In some embodiments, control software 150 is also downloaded to design-application apparatus 105 from computer 110.

Computer 110 includes a processor 155 that communicates over data bus 160 with memory 165 and communication interface 170. In one embodiment, computer 110 is a personal computer (PC) running an operating system such as Microsoft's WINDOWS. In other embodiments, a different type of computer and/or operating system can be used. As mentioned above, computer 110, in some embodiments, may be operated as a server.

In this illustrative embodiment, memory 165 includes host software 175. As with memory 135, depending on the particular embodiment, memory 165 may include, without limitation, random-access memory (RAM), read-only memory (ROM), flash memory, magnetic disk storage, optical storage, other types of memory, or a combination thereof.

Host software 175 includes, among other functions, one or more routines for compensating for misalignment of a target piece of material on design-application apparatus 105. In one embodiment, host software 175 employs coordinate-transformation techniques to adjust design data 145 so as to compensate for translational misalignment, rotational misalignment, or both. The result is that the design is applied to the target piece of material correctly despite such misalignment. Optionally, the design may also be scaled in size. This is explained in further detail below.

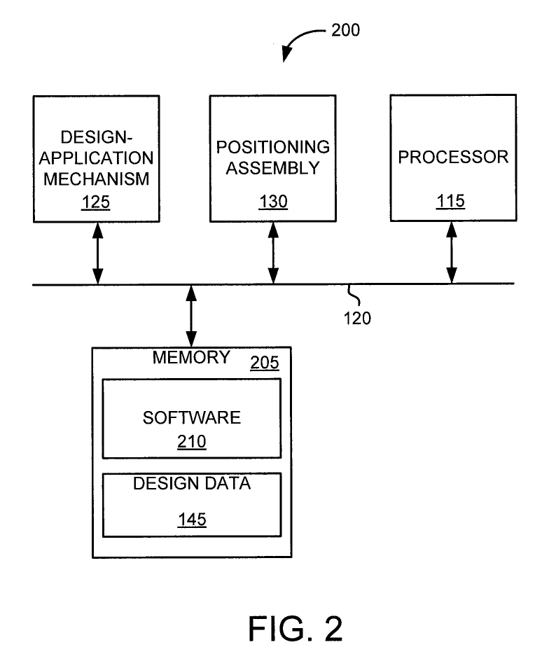

FIG. 2 is a functional block diagram of a design-application apparatus 200 in accordance with another illustrative embodiment of the invention. Design-application apparatus 200 includes a processor 115 that communicates over data bus 120 with design-application mechanism 125, positioning assembly 130, and memory 205. Unlike system 100 shown in FIG. 1, in this embodiment the functionality of system 100 resides in a single apparatus (design-application apparatus 200). The functionality of control software 150 and host software 175 is included in software 210, and the design repository (not shown in FIG. 2) is also stored in design-application apparatus 200 (e.g., in memory 205).

In general, the various functional units described above in connection with FIGS. 1 and 2 can be subdivided or combined in ways other than those indicated in these figures, and those functional units can be implemented in hardware, firmware, software, or a combination thereof, depending on the particular embodiment. The implementations shown in FIGS. 1 and 2 are merely illustrative. In some embodiments, one or more of these functional units are implemented as program instructions executable by a processor and stored on a computer-readable storage medium such as a floppy disk, flash-memory device, optical disc, or magnetic disk.

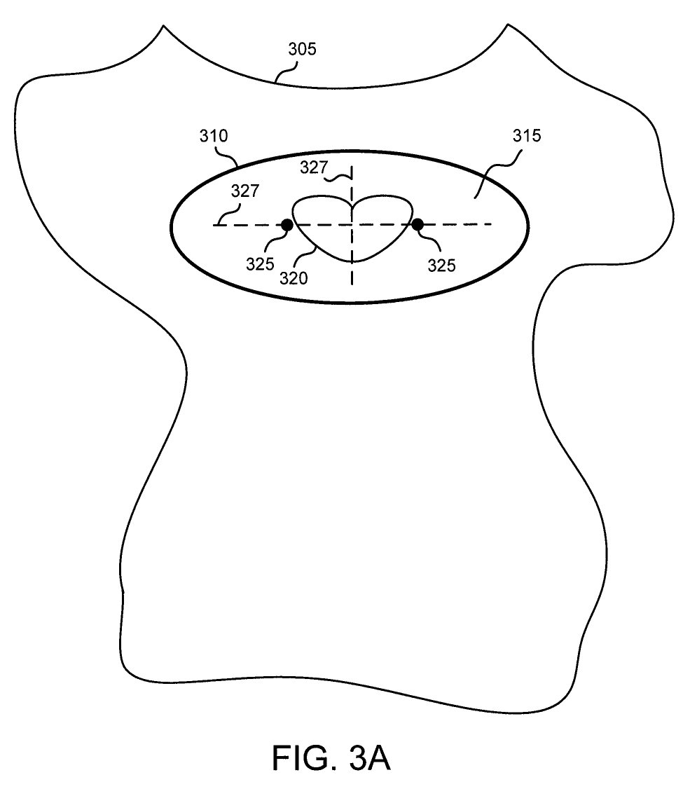

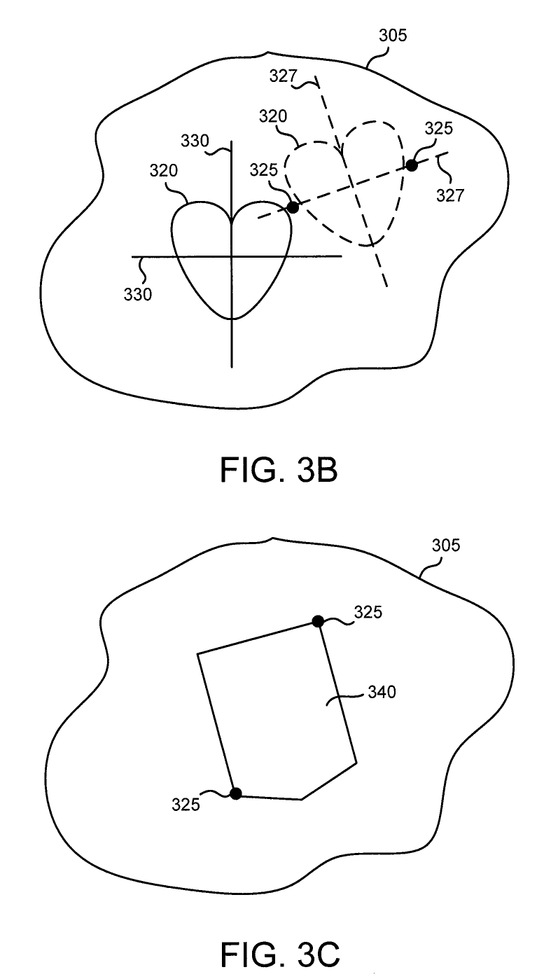

FIG. 3A is an illustration of a target piece of material 305 that has been placed in a hoop 310 and on which at least two reference points (or registration marks) 325 have been defined in accordance with an illustrative embodiment of the invention. In the situation illustrated in FIG. 3A, a design 320 is to be applied to a target piece of material 305. For example, design 320 may be embroidered or printed on target piece of material 305. The area inside hoop 310 may be referred to as the design-application area 315.

In other embodiments, means other than hoop 310 for securing the target piece of material 305 to the design-application apparatus can be used. For example, a clamp, rack system, or tray can be used instead of hoop 310, depending on the particular embodiment.

In some embodiments, reference points 325 are added to target piece of material 305 by a machine or human operator as visible marks. In other embodiments, reference points 325 are defined in terms of a feature such as a patch, pocket, or pattern of target piece of material 305. In some applications, both a printed design and an embroidered design may be applied to the same target piece of material 305. In such applications, reference points 325 for the embroidering process can be defined in terms of features (e.g., vertices or corners) of the printed design.

However the reference points 325 are defined on target piece of material 305, design data 145 specifies a particular position and orientation, on target piece of material 305, of the design 320 with respect to the reference points 325. That is, the spatial information contained in design data 145 is generated with respect to a particular coordinate system with coordinate axes 327, and the reference points 325 occupy known locations in that coordinate system. In the particular embodiment shown in FIG. 3A, reference points 325 are shown as lying along an axis 327 of the coordinate system associated with design data 145, but that is not a requirement in all embodiments.

If target piece of material 305 is placed in hoop 310 such that the axes 327 of the coordinate system with respect to which design data 145 is generated align with the axes of the coordinate system employed by design-application apparatus (105 or 200), design data 145 can be used without modification to apply design 320 to target piece of material 305. If target piece of material 305 is instead placed in hoop 310 imperfectly (offset and/or rotated), design data 145 can be modified, as explained below, to correct for the misalignment so that target piece of material 305 does not need to be physically repositioned.

FIG. 3B is an illustration showing a situation in which the target piece of material 305 has been misaligned with respect to the design-application mechanism 125 in accordance with an illustrative embodiment of the invention. FIG. 3B shows a portion of design-application area 315 within hoop 310.

In FIG. 3B, due to both translational and rotational misalignment of target piece of material 305 within hoop 310, the axes 327 on which original design data 145 is based do not align with axes 330 of the coordinate system used by design-application apparatus (105 or 200). For example, an embroidery machine may employ such a coordinate system in conjunction with its X-Y assembly. Depending on the particular situation, the misalignment may be more or less severe than indicated in FIG. 3B. Also, in some situations, only translational or only rotational misalignment might occur.

The solid portion of FIG. 3B indicates where on target piece of material 305 design 320 would be applied based on the original (unmodified) design data 145. The dashed portion of the figure indicates where design 320 should actually be placed due to the misalignment. As noted above, the reference points 325 uniquely determine the correct position and orientation of design 320 on target piece of material 305.

In illustrative embodiments of the invention, system 100 or design-application apparatus 200 can compensate for misalignment such as that illustrated in FIG. 3B as follows. First, an operator places a target piece of material 305 in a hoop 310 and attaches hoop 310 to the design-application apparatus (e.g., to an X-Y assembly of an embroidery machine). The operator observes where a first reference point 325 is located on target piece of material 305. With the aid of positioning assembly 130, the operator repositions target piece of material 305 as needed until a position indicator (e.g., a dot of light, in the case of an optical positioning assembly) of positioning assembly 130 coincides with the first reference point 325. At that point, the operator actuates an input control of the design-application apparatus (105 or 200), causing design-application apparatus (105 or 200) to determine and record a first set of coordinates, in the device's coordinate system, corresponding to that location.

The operator repeats the above procedure for the second reference point 325 to produce a second set of coordinates corresponding to the location, in the device's coordinate system, of the second reference point 325. The first and second sets of coordinates thus correspond to the physical locations on target piece of material 305 of the first and second reference points 325, respectively.

Host software 175 or software 210 can use the first and second sets of coordinates to modify design data 145 so as to compensate for misalignment of the target piece of material 305. For example, the first and second sets of coordinates can be used to locate coordinate axes 327 with respect to which original design data 145 was generated. Using mathematical techniques well known to those skilled in the art, design data 145 can be modified to account for the misalignment. In one embodiment, the first and second sets of coordinates are used in performing a coordinate transformation from the coordinate system with respect to which original design data 145 was generated to the coordinate system used by the design-application apparatus (105 or 200). Such a coordinate transformation maps each point of design 320 as specified by original design data 145 with respect to axes 327 to a new point in the coordinate system defined by axes 330.

Control software 150 or software 210 then causes design-application mechanism 125 to apply design 320 to target piece of material 305 in accordance with the modified or transformed design data. The result is that design 320 is applied at the correct position and in the correct orientation with respect to reference points 325 despite the misalignment of target piece of material 305.

The coordinate system defined by axes 330 can be defined, for example, in terms of a particular “home position” of an X-Y assembly or other mechanism for moving the target piece of material relative to a stitching or printing assembly. This “home position” can be established and maintained through a calibration procedure.

In the embodiment shown in FIG. 1, the first and second sets of coordinates are transmitted over communication link 180 from design-application apparatus 105 to computer 110. If necessary, design data 145 is modified by host software 175 on computer 110 based on the received first and second sets of coordinates, and the modified (corrected) design data is transmitted back to design-application apparatus 105 over communication link 180. Control software 150 then controls the operation of design-application mechanism 125 in applying the design 320 to target piece of material 305 in accordance with the modified design data.

In the embodiment shown in FIG. 2, the operations just described are all performed within design-application apparatus 200.

FIG. 3C is an illustration showing reference points 325 that are defined in terms of a feature of the target piece of material 305 other than added visible marks in accordance with an illustrative embodiment of the invention. In the example of FIG. 3C, a target piece of material (e.g., a garment) includes a pocket 340. Reference points 325 have been defined at two of the corners of pocket 340. In such a case, it would be unnecessary to add visible marks to target piece of material 305. Instead, an operator can simply use the predetermined corners of pocket 340 as the reference points 325. In such an embodiment, the design data 145 associated with a particular design 320 would take into account the locations of the reference points 325 in the coordinate system with respect to which design data 145 is generated.

In some embodiments, host software 175 or software 210 is configured, in addition to correcting for misalignment, to scale the design 320 in size relative to a reference size (e.g., that specified by the corresponding original design data 145). In this embodiment, design data 145 is modified to take into account the desired scale factor. Scaling of the design 320 can be combined with coordinate transformation in accordance with techniques that are well known in the mathematical and graphical arts. The ability to scale a design 320 is useful for applications in which a design 320, as specified by design data 145, is too large or too small for its intended use on target piece of material 305. For example, design data 145 might specify that a particular design 320 is to occupy an area 4″×3″, whereas the design 320 needs to be embroidered on a garment within an area of only 2″×1.5″ (e.g., within a sewn-on patch).

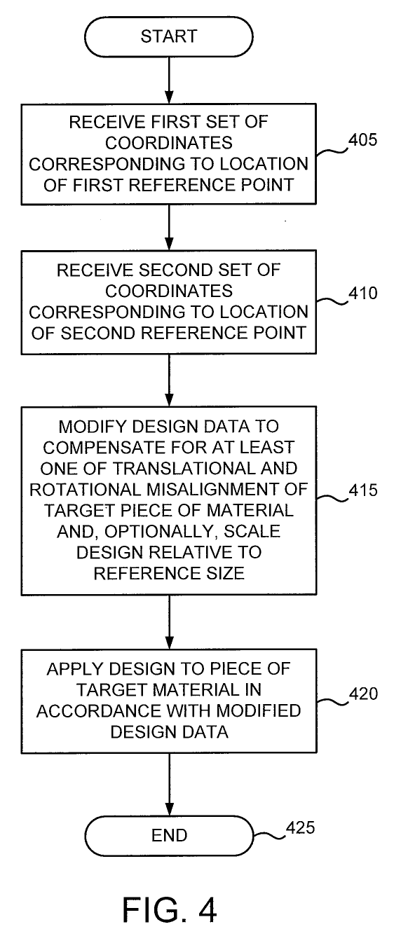

FIG. 4 is a flowchart of a method for applying a design to a target piece of material in accordance with an illustrative embodiment of the invention. At 405, host software 175 or software 210 receives a first set of coordinates corresponding to the location, on target piece of material 305, of a first reference point 325. At 410, host software 175 or software 210 receives a second set of coordinates corresponding to the location, on target piece of material 305, of a second reference point 325.

At 415, based on the received first and second sets of coordinates, host software 175 or software 210 modifies the design data 145 corresponding to design 320 to compensate for misalignment of target piece of material 305, as described above. As noted above, in modifying design data 145, host software 175 or software 210 may employ mathematical techniques such as coordinate transformation to shift and/or rotate the design 320 to correct for the misalignment.

At 420, design-application mechanism 125 applies the design 320 to target piece of material 305 under control of control software 150 or software 210 in accordance with the modified design data produced at 415. At 425, the process terminates.

As discussed above, in some embodiments, modifying the design data 145 at 315 includes, in addition to correcting for misalignment, scaling the design in size relative to a reference size (e.g., the size specified by the original design data 145).

In conclusion, the present invention provides, among other things, a method and system for compensating for misalignment of a target piece of material to which a design is to be applied. Those skilled in the art can readily recognize that numerous variations and substitutions may be made in the invention, its use, and its configuration to achieve substantially the same results as achieved by the embodiments described herein. Accordingly, there is no intention to limit the invention to the disclosed exemplary forms. Many variations, modifications, and alternative constructions fall within the scope and spirit of the disclosed invention as expressed in the claims.

What is claimed is:

1. A method for applying a design to a target piece of material, the method comprising:
receiving a first set of coordinates corresponding to a location of a first reference point on the target piece of material;
receiving a second set of coordinates corresponding to a location of a second reference point on the target piece of material;
modifying, based on the received first and second sets of coordinates, design data that specifies a predetermined position and orientation of the design on the target piece of material with respect to the first and second reference points to produce modified design data, the modified design data compensating for at least one of translational and rotational misalignment of the target piece of material with respect to a design-application mechanism; and
applying the design to the target piece of material in accordance with the modified design data.

2. The method of claim 1, wherein, the target piece of material is at least a portion of a garment.

3. The method of claim 1, wherein applying the design to the target piece of material in accordance with the modified design data includes embroidering the design on the target piece of material.

4. The method of claim 1, wherein applying the design to the target piece of material in accordance with the modified design data includes printing the design on the target piece of material.

5. The method of claim 1, wherein the modifying includes modifying the design data such that the design is scaled in size relative to a reference size when the design is applied to the target piece of material in accordance with the modified design data.

6. The method of claim 1, wherein at least one of the first and second reference points is located by an operator with the aid of an optical positioning assembly.

7. The method of claim 1, wherein at least one of the first and second reference points is located by an operator with the aid of a mechanical positioning assembly.

8. The method of claim 1, wherein at least one of the first and second reference points corresponds to a visible mark added to the target piece of material.

9. The method of claim 1, wherein at least one of the first and second reference points is defined in terms of a feature of the target piece of material other than an added visible mark.

10. The method of claim 1, wherein the modified design data is produced by using the received first and second sets of coordinates to perform coordinate transformation.

11. A system for applying a design to a target piece of material, the system comprising:
a design-application apparatus including:
a design-application mechanism;
a first processor;
design data specifying a predetermined position and orientation of the design on the target piece of material with respect to first and second reference points on the target piece of material; and
control software; and
a computer including:
a second processor; and
host software configured to cause the second processor to:
receive from the design-application apparatus, via a communication link between the design-application apparatus and the computer, a first set of coordinates corresponding to a location of the first reference point on the target piece of material;
receive from the design-application apparatus, via the communication link, a second set of coordinates corresponding to a location of the second reference point on the target piece of material;
modify, based on the received first and second sets of coordinates, the design data to produce modified design data, the modified design data compensating for at least one of translational and rotational misalignment of the target piece of material with respect to the design-application mechanism; and
transmit the modified design data to the design-application apparatus via the communication link;
wherein the control software is configured, after receipt of the modified design data, to cause the first processor to control the design-application mechanism in applying the design to the target piece of material in accordance with the modified design data.

12. The system of claim 11, further comprising:
an optical positioning assembly to aid an operator in locating at least one of the first and second reference points.

13. The system of claim 12, wherein the optical positioning assembly includes a laser that shines a dot of visible light onto the target piece of material.

14. The system of claim 11, further comprising:
a mechanical positioning assembly to aid an operator in locating at least one of the first and second reference points.

15. The system of claim 11, wherein, the target piece of material is at least a portion of a garment.

16. The system of claim 11, wherein the design-application apparatus is a stitching apparatus.

17. The system of claim 11, wherein the design-application apparatus is a printing apparatus.

18. The system of claim 11, wherein the host software is configured to cause the second processor to modify the design data such that the design is scaled in size relative to a reference size when the design-application apparatus applies the design to the target piece of material in accordance with the modified design data.

19. The system of claim 11, wherein at least one of the first and second reference points corresponds to a visible mark added to the target piece of material.

20. The system of claim 11, wherein at least one of the first and second reference points is defined in terms of a feature of the target piece of material other than an added visible mark.

21. The system of claim 11, wherein the host software is configured to cause the second processor to produce the modified design data by using the received first and second sets of coordinates to perform coordinate transformation.

22. An apparatus for applying a design to a target piece of material, the apparatus comprising:
a design-application mechanism;
a processor;
design data specifying a predetermined position and orientation of the design on the target piece of material with respect to first and second reference points on the target piece of material; and
program instructions configured to cause the processor to:
receive a first set of first coordinates corresponding to a location of the first reference point on the target piece of material;
receive a second set of coordinates corresponding to a location of the second reference point on the target piece of material;
modify, based on the received first and second sets of coordinates, the design data to produce modified design data, the modified design data compensating for at least one of translational and rotational misalignment of the target piece of material with respect to the design-application mechanism; and
control the design-application mechanism in applying the design to the target piece of material in accordance with the modified design data.

23. The apparatus of claim 22, further comprising:
an optical positioning assembly to aid an operator in locating at least one of the first and second reference points.

24. The apparatus of claim 23, wherein the optical positioning assembly includes a laser that shines a dot of visible light onto the target piece of material.

25. The apparatus of claim 22, further comprising:
a mechanical positioning assembly to aid an operator in locating at least one of the first and second reference points.

26. The apparatus of claim 22, wherein the program instructions are configured to cause the processor to modify the design data such that the design is scaled in size relative to a reference size when the design-application apparatus applies the design to the target piece of material in accordance with the modified design data.

27. The apparatus of claim 22, wherein the program instructions are configured to cause the processor to produce the modified design data by using the received first and second sets of coordinates to perform coordinate transformation.

28. A computer-readable storage medium containing program instructions executable by a processor for applying a design to a target piece of material, the computer-readable storage medium comprising:
a first instruction segment configured to receive a first set of coordinates corresponding to a location of a first reference point on the target piece of material;
a second instruction segment configured to receive a second set of coordinates corresponding to a location of a second reference point on the target piece of material;
a third instruction segment configured to modify, based on the received first and second sets of coordinates, design data that specifies a predetermined position and orientation of the design on the target piece of material with respect to the first and second reference points to produce modified design data, the modified design data compensating for at least one of translational and rotational misalignment of the target piece of material with respect to a design-application mechanism; and
a fourth instruction segment configured to control the design-application mechanism in applying the design to the target piece of material in accordance with the modified design data.

29. The computer-readable storage medium of claim 28, wherein the third instruction segment is configured to modify the design data such that the design is scaled in size relative to a reference size when the design is applied to the target piece of material in accordance with the modified design data by the design-application mechanism.
